(19) United States
(12) Patent Application Publication
(10) Pub. No.: US 2024/0348128 A1
(43) Pub. Date: Oct. 17, 2024

(54) Cooling Arrangements for an Electromotive Drive Unit and Components Thereof

(71) Applicant: Bayerische Motoren Werke Aktiengesellschaft, Muenchen (DE)

(72) Inventors: Benjamin KRANK, Muenchen (DE); Matthias LEPSCHI, Muenchen (DE); Robin MAROTZKE, Muenchen (DE); Thomas PROSSER, Unterschleissheim (DE); Anastasois VICHOS, Vaterstetten (DE); Bernhard WOLF, Muenchen (DE)

(21) Appl. No.: 18/683,313

(22) PCT Filed: Sep. 6, 2022
(86) PCT No.: PCT/EP2022/074669

§ 371 Date: Feb. 13, 2024

(30) Foreign Application Priority Data
Oct. 4, 2021 (DE) 10 2021 125 659.3

(51) Int. Cl. H02K 9/197; H02K 9/193

(52) U.S. Cl. CPC H02K 9/197; H02K 9/193

(57) ABSTRACT

A stator cooling arrangement for a stator of an electric drive engine in a motor vehicle, having stator core cooling with a first coolant and stator winding head cooling with a second coolant which differs from the first coolant.

### BACKGROUND AND SUMMARY

The invention relates to a stator cooling arrangement for a stator of an electric drive engine in a motor vehicle, a drive cooling arrangement with a stator cooling arrangement and a rotor cooling arrangement, as well as an electromotive drive unit for a motor vehicle with a drive cooling arrangements. Furthermore, the invention relates to a method for the operation of a drive cooling arrangement.

In various known motor vehicles driveable by electromotive means, the electric drive engine is cooled with an electrically non-conductive oil, for example a gear oil, as a coolant. The oil is usually used here both for the lubrication and cooling of the drive engine as well as the cooling of its output gear. An oil-water heat exchanger is typically used here, which emits the introduced heat from the oil to the vehicle cooling circuit. The drive engine and its output gear normally comprise a common oil sump (also referred to hereinafter as an oil collector). The oil is pumped from the latter into an oil-water heat exchanger by an electrical or mechanical oil pump. The oil emits heat in the heat exchanger to the vehicle cooling circuit. Before the oil pump, before the oil-water heat exchanger or after the oil-water heat exchanger, an oil filter can be integrated for filtering particles and for defoaming the oil. A part of the oil mass flow is used for the lubrication of the gearing (e.g. bearings, tooth meshing, etc.) and a part of the oil mass flow is used for cooling the drive engine.

Such a cooling oil circuit is known for example from DE 10 2017 201 117 A1, wherein the stator there is cooled with a water jacket, and also from WO 2015/116496, where stator and rotor are oil-cooled.

Against this background, it is a problem of the invention to improve a temperature control, in particular cooling, of a stator of an electric drive engine and/or an electromotive drive unit.

Each of the independent claims specifies an article with its features, which solves this problem. The dependent claims relate to advantageous developments of the invention.

According to one aspect, a stator cooling arrangement is specified for a stator of an electric drive engine in a motor vehicle. The stator cooling arrangement comprises stator core cooling with a first coolant and stator winding head cooling with a second coolant, which differs from the first coolant, in particular with regard to a selection of different cooling fluids as the first cooling agent and as the second cooling agent.

Stator cooling can thus be achieved, the basic cooling load of which for the (frequently occurring) operating conditions can be brought about far removed from a maximum cooling load, for example water. Such a first coolant is present anyway in a relatively large volume in typical motor vehicles and can thus be used with little effort for the direct cooling and/or for the heat transfer from another, in particular second, coolant.

Such operating conditions, in which a higher cooling load is required, can then be covered by a second coolant, which is suitable for a higher specific heat removal, for example a gear oil. For example, when use is made of gear oil as a second coolant, it is advantageous not to use such a second coolant to cover the basic cooling load, because there is a risk of greater friction losses due to its higher viscosity, especially when the second coolant is used in a workspace of the engine (wet running), especially when it gets into a gap between rotor and stator.

In particular, both coolants, the first and the second, are fluid, i.e. are present in fluid form at least in the temperature range of their use.

According to an embodiment, the stator core cooling comprises a cooling jacket, in particular in a stator housing, in particular a water cooling jacket. A basic heat removal for a basic cooling load of the stator cooling can thus be brought about. According to an embodiment, the first coolant is arranged outside a workspace of the electric drive engine.

According to an embodiment, the stator winding head cooling comprises one or more outlet openings arranged radially outside the stator winding heads for the second coolant, in particular from a line arranged in a stator housing for the second coolant, through which the second coolant can be injected into the workspace of the electric drive engine, in particular onto the stator winding heads. A sufficient heat removal can thus also be brought about—in particular in cooperation with that of the stator core cooling—with a cooling load peak of the stator cooling.

According to an embodiment, a plurality of outlet openings arranged distributed in the circumferential direction, in particular uniformly and/or in the upper circumferential half, are provided for each stator winding head side, in order to be able to thoroughly wet the entire circumference with coolant even with a standstill or low speeds.

According to an embodiment, the second coolant of the stator winding head cooling is electrically non-conductive. There is thus no need to insulate the stator and rotor electrically with respect to one another, in order to implement spray cooling in the workspace of the electric engine.

According to an embodiment, one of the two coolants is a water-based coolant, in particular a cooling water, and the other of the two coolants is an, in particular electrically non-conductive, oil-based coolant, in particular a cooling oil. The stator core can thus be cooled with a water jacket, for example from the cooling water installed anyway for the interior air-conditioning, which is available in relatively large quantities. The stator winding heads can then be cooled with a gear oil of an electromotive drive unit, which comprises the electric drive engine and an output gear.

According to a further aspect, a drive cooling arrangement is specified, comprising a stator cooling arrangement according to an embodiment of the invention and a rotor cooling arrangement, which is formed with the second coolant, i.e. in particular forms a heat removal by the second coolant.

According to an embodiment, the drive cooling arrangement comprises a second coolant circuit, in particular a cooling oil circuit, which is constituted for the supply of the stator cooling arrangement, in particular only the stator winding head cooling therein, and the rotor cooling arrangement with the second coolant.

According to a further aspect, an electromotive drive unit for a motor vehicle is specified, comprising an electric drive engine and an output gear for the electric drive engine, and a stator cooling arrangement according to an embodiment of the invention or a drive cooling arrangement according to an embodiment of the invention.

According to a further aspect, a method for the operation of a drive cooling arrangement according to an embodiment of the invention is specified, comprising at least the process steps (I) determination of an operating state of the drive engine; (II) switching of a branch valve of the second coolant circuit depending on the ascertained operating state.

The effect of this is that the gearing can be lubricated, depending on the operating state, faster or immediately, with optimally temperature-controlled cooling oil, in particular as long as no cooling of the electric engine is required.

According to an embodiment, the branch valve wholly or partially closes the engine cooling path when a low load and/or a cold start is ascertained as the operating state.

According to an embodiment, the branch valve frees the engine cooling path when an operating state is ascertained which requires cooling of the drive engine, wherein such an operating state is present in particular when a limiting temperature and/or a limiting temperature gradient of the drive engine is exceeded. Sufficient cooling of the drive engine is thus ensured.

Amongst other things, the invention is based on the knowledge that the continuous torque is dimensioned in the low speed range up to approx. 5000 rpm for electrically excited synchronous engines—but also for externally excited synchronous engines or asynchronous engines—as drive engines in a motor vehicle. A high cooling performance in this operating range thus enables the use of a more compact and lightweight engine.

In this low speed range, the cooling performance of stator cooling purely with a water jacket is not optimum, since the stator cooling heads are cooled only by cooling oil spraying from the shaft and this oil in the low speed range does not get to all the components to be cooled on account of the low dynamics. In addition, the components in the outer region and the periphery of the stator winding heads (e.g. stator terminal wires) are generally only slightly cooled, since the cooling oil is fed from inside.

A significant drawback of pure oil cooling, on the other hand, is high friction losses due to spray oil in the engine even in the low load range. In a cooling concept with the stator cooling arrangement according to the invention, oil spray cooling can be dispensed with over a wide operating range of the drive engine, which significantly increases the overall efficiency of the drive in the normal customer operation.

According to an embodiment, a first coolant circuit is provided for the first coolant and a second coolant circuit is provided for the second coolant. According to an embodiment, the two coolant circuits cooperate, in that they comprise a heat transfer point, at which they form a heat exchanger for the, in particular mutual, transfer of thermal energy. The heat of the stator can thus be removed efficiently and/or by different methods.

According to an embodiment, the first coolant of the stator core cooling is a water-based coolant and/or the second coolant of the stator winding head cooling is an oil-based coolant. Stator cooling can thus be achieved, a basic cooling load of which for the (frequently occurring) operating conditions that is far removed from a maximum cooling load can be brought about with a first coolant which is present anyway in a relatively large volume in typical motor vehicles. Such operating conditions, in which a higher cooling load is required, can then be brought about by a second coolant, which is suitable for a higher specific heat removal.

According to an embodiment, the second coolant circuit of the stator cooling arrangement and/or the drive cooling arrangement comprises an engine cooling path for cooling the stator and/or the drive engine, by which the stator winding head cooling and/or the rotor cooling is constituted. In particular, the second coolant circuit is constituted for an electromotive drive unit of a motor vehicle, wherein the drive unit comprises an electric drive engine and an output gear. According to an embodiment, the second coolant circuit comprises a gear temperature-control path for cooling the output gear.

According to an embodiment, the second coolant circuit comprises a junction upstream of a heat exchanger of the stator cooling arrangement, at which junction the engine cooling path and the gear temperature-control path are split up. The effect of this is that a temperature level of the cooling of the drive engine can be influenced independently of a temperature level of the cooling of the output gear.

According to an embodiment, a branch valve is provided in the second coolant circuit for the adjustment of an oil flow at the junction, which branch valve can assume an open state and a closed state, wherein the engine cooling path is blocked in the closed state. Oil cooling of the stator winding heads for reducing friction losses can thus be prevented or reduced, as long as—for example in the case of a cold start—cooling of the drive engine is not required; but rapid reaching of the operating temperature of the gearing is required.

According to an aspect, a second cooling circuit, in particular a cooling oil circuit, is specified for a drive cooling arrangement of an electromotive drive unit of a motor vehicle, which in particular is constituted according to an embodiment of the invention, and wherein the drive unit comprises an electric drive engine and its output gear. The coolant circuit comprises at least (a) an oil pump for conveying cooling oil, which is collected in an oil collector, in an oil mass flow; (b) an engine cooling path for cooling the electric drive engine, in particular the components in an interior of an engine housing, which extends from the oil pump up to this oil collector and downstream of an engine cooling section passes through a heat exchanger for cooling the cooling oil, in particular an oil-oil or oil-water heat exchanger, and (c) a gear temperature-control path for cooling and/or heating the output gear, in particular the components in an interior of a gear housing, which extends from the oil pump up to the oil collector.

The second coolant circuit, and therefore in particular also an oil mass flow (i.e. a mass flow of the second coolant), comprises a junction between the oil pump and the heat exchanger, at which junction the engine cooling path and the gear temperature-control path are split up. The effect of this is that a temperature level of cooling of the drive engine can be influenced independently of a temperature level of cooling of the output gear, in particular when the engine cooling path in a drive cooling arrangement is constituted according to an embodiment of the invention with a branch valve.

The embodiments of the invention in which the engine cooling path can be wholly or partially blocked by the branch valve are based amongst other things on the consideration that oil that is cooled as well as possible is advantageous for the drive engine in the temporally most frequent operating conditions, whereas oil at operating heat is advantageous for the gearing in the temporally most frequent operating conditions, since the oil has a temperature-dependent viscosity and thus causes high friction and splash losses at low temperatures. These embodiments are based amongst other things on the knowledge that such operating conditions, in which cooling of the drive engine is important and those operating conditions in which heating of the components of the output gear brings the greatest advantage, seldom occur together. This knowledge opens up a route for (at least largely) solving the conflict of aims with regard to oil temperature, in particular by a modification of the pressure oil architecture. In the sense of these embodiments, only the oil mass flow is cooled by the oil-water heat exchanger, which is used for cooling the E-engine. For this purpose, a heat exchanger bypass is created for the remaining oil mass flow, which is used for the temperature control of the output gear. In other words, the splitting-up of the entire oil mass flow into parallel paths, of which one controls the temperature of the drive engine and the other that of the output gear, already takes place before the heat exchanger at a junction. Since the oil from E-engine and gearing is mixed in the oil sump, the oil for the lubrication of the gearing is also indirectly cooled, but an approx. 10 to 15 Kelvin higher temperature quickly results—for example with a cold start—at the injection nozzles for the lubrication of the gearing than in an otherwise comparable operation with a conventional cooling circuit topography at the same relative point in time. This results in an advantageously lower oil viscosity due to a higher oil temperature and therefore higher efficiency due to smaller splash losses in the gearing, and an advantageously lower pressure loss and therefore lower 12V pump consumption as well as the potential for smaller dimensioning of the oil pump.

According to an embodiment, a branch valve is used for the desired splitting-up of the oil mass flows in an engine cooling path and a gear temperature-control path, which shuts off the oil mass flow in the direction of the E-engine at low load. The valve can be positioned before or after the oil-water heat exchanger. The valve can be constituted active (e.g. electric switching valve) or passive (e.g. pressure-regulated volume flow-regulated switching valve). This results in a reduction of the fluid friction losses in the E-engine.

According to an embodiment, the gear temperature-control path downstream of the junction is constituted as a gear cooling section, in particular guided from the junction directly, i.e. in particular without bypass, which has another main reason as installation space specifics, up to and/or into the gear housing. The cooling oil can thus be used for the temperature control of the gearing roughly at a temperature level at which it leaves the oil collector.

According to an embodiment, the gear temperature-control path is guided past the heat exchanger to the gear housing, i.e. in particular is constituted as a heat exchanger bypass. The effect of this is that the gearing can be lubricated in the case of a cold start more quickly with cooling oil at operating heat.

According to an embodiment, the engine cooling path and the gear temperature-control path end, in particular independently of one another, in the oil collector. The effect of this can be that a temperature level of cooling of the drive engine can be influenced completely independently of a temperature level of cooling of the output gear.

According to an embodiment, the engine cooling path merges into the gear temperature-control path, in particular into the gear housing. The second coolant circuit can thus be constituted more simply and therefore, as the case may be, more advantageously and/or more compactly. For example, the oil collector can be constituted on a base of the gear housing.

According to an embodiment, a branch valve is provided in the second coolant circuit for adjusting an oil flow at the junction, which branch valve can assume an open state and a closed state, wherein the engine cooling path is blocked in the closed state. Oil cooling can thus be prevented, as long as—for example in the case of a cold start—cooling of the drive engine is not required, but rather rapid reaching of the operating temperature of the gearing is required.

According to an embodiment, the branch valve in the engine cooling path is arranged upstream or downstream of the heat exchanger depending on the point at which a more suitable installation space is present.

According to an embodiment, the branch valve can assume one, in particular one of a plurality of partially open states, in which the oil mass flow on the machine cooling path and the gear temperature-control path are split up into a predetermined ratio. Splitting-up of the oil mass flow proportions can thus take place on the basis of a prioritization of the importance of cooling of the drive engine on the one hand and on the other hand heating of the gearing to an operating temperature.

According to an embodiment, the branch valve is a valve which can be switched by a control or regulation. With such an active branch valve, for example an electric switching valve, a desired valve position can be assumed depending on the parameters to be taken into account. The control of such a valve can take place electronically, hydraulically or in another way.

According to an embodiment, the branch valve is switched depending on an operating parameter of the second coolant circuit, in particular on an oil pressure and/or an oil volume flow and/or an oil temperature at a predetermined point in the second coolant circuit such as for example in the oil collector. Such switching can for example be optimized for the lowest possible fluid friction losses in the drive engine and/or in the output gear.

A parameter for the control of the valve can be a temperature value, in particular a gear oil temperature measured at a specific point. According to an embodiment, a temperature sensor is provided, which detects the temperature of the gear oil at a predetermined point and feeds a corresponding temperature signal to the control or regulation.

According to an embodiment, the engine cooling comprises rotor cooling and/or stator cooling. In particular, the stator cooling comprises stator core cooling and/or stator winding head cooling. With such embodiments, the invention can be used with different cooling concepts for a drive engine and the associated output gear.

In phases in which the gear oil has not yet reached its optimum operating temperature, the branch valve blocks the engine cooling path, the effect of which is that no or only little gear oil flows through the heat exchanger and so the oil quantity present in the gearing heats up more rapidly to the optimum operating temperature, which acts favorably on the degree of efficiency of the gearing and thus of the vehicle. There is also a favorable effect from the fact that a total flow resistance is smaller in the closed state of the branch valve and accordingly less pumping power is required.

It should be expressly pointed out that the branch valve can either be a valve which can solely assume the two states “open or closed”, or also a “proportional valve”, i.e. a valve which can assume arbitrary intermediate positions in which it is partially opened.

According to an embodiment, the electric oil pump can be regulated as required. Demands for the increase in the oil mass flow can be tripped for example by the rotor temperature, the stator temperature, the speed, the transmitted torque, the oil temperature and/or the differential speed of the two output shafts (left, right). The demand-controlled regulation has three significant advantages: a higher pump control requires more electric power, which lowers the range of the vehicle. A higher pump control also increases the oil friction losses in the gearing and the E-engine, which also has an unfavorable effect on the range of the vehicle. Furthermore, a low oil pump control leads to more rapid heating of the oil in the case of a cold start, which also creates advantages in the efficiency on account of the temperature dependence of the viscosity of the oil.

According to an embodiment, monitoring electronics can be provided for safety reasons, which detect whether specific fault states are present. In the presence of a fault state, provision can be made such that the branch valve is/remains open, so that the flow through the heat exchanger continues and the cooling of the gear oil is maximized. Alternatively or in addition, provision can be made such that, in the presence of a fault, the gearing and/or the drive engine of the motor vehicle are switched into emergency mode, in which the gearing and/or the drive engine of the vehicle can only be operated with limited power.

As an alternative to the switchable branch valve, the branch valve according to an embodiment can also be constituted by a simple “thermostat valve”. Conventional thermostat valves usually comprise an “expansion element”, which completely or partially closes or opens the thermostat valve depending on the temperature prevailing there.

Further advantages and possibilities of use of the invention emerge from the following description in connection with the figures, which are understood to be diagrammatic sketches.

### BRIEF DESCRIPTION OF THE DRAWINGS

FIG. 1 shows an electromotive drive unit with a stator cooling arrangement and a drive cooling arrangement according to a first exemplary embodiment of the invention,

FIG. 2 shows an electromotive drive unit with a stator cooling arrangement and a drive cooling arrangement according to a second exemplary embodiment of the invention,

FIG. 3 shows an electromotive drive unit with a stator cooling arrangement and a drive cooling arrangement according to a third exemplary embodiment of the invention, and

FIG. 4 shows an exemplary embodiment of stator winding head cooling, which can be used in all the exemplary embodiments of FIG. 1, 2 or 3.

### DETAILED DESCRIPTION OF THE DRAWINGS

Components which in different exemplary embodiments perform at least essentially the same function and/or are at least essentially constituted the same are provided with the same reference numbers in the different examples.

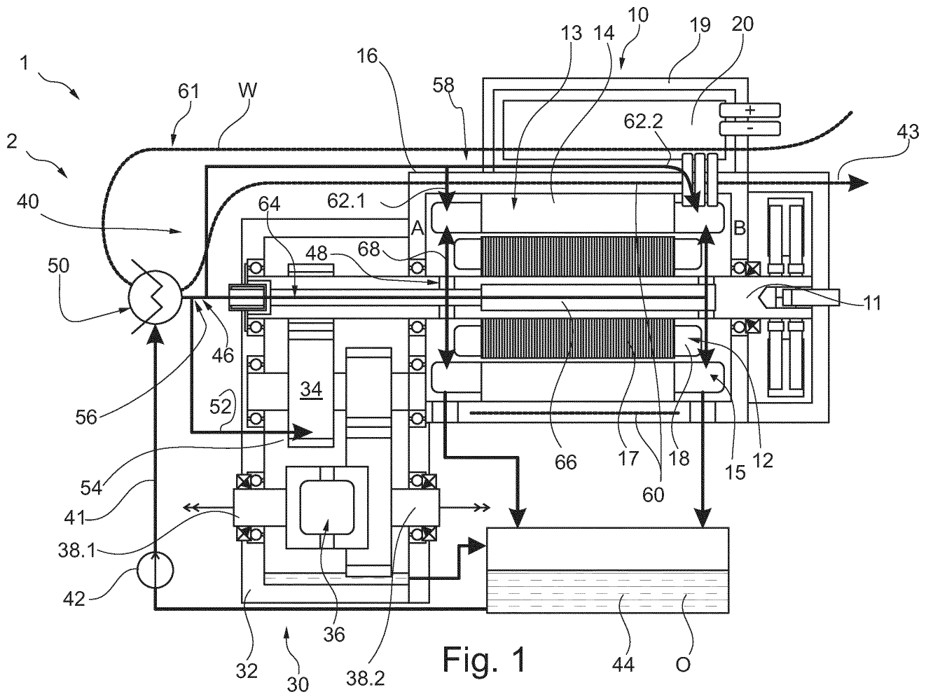

FIG. 1 shows an electromotive drive unit 100 for a motor vehicle, comprising an electric drive engine 10 and an output gear 30 for drive engine 10, wherein a rotor shaft 11 of a rotor 12 of drive engine 10 is the input shaft of gear 30.

Drive engine 10 is an externally excited synchronous engine, so that rotor 12 comprises a rotor core 17 and rotor winding heads 18. The present disclosure can however—if necessary adapted as part of the skilled craftsman's trade—also be used on permanently excited synchronous engines and asynchronous engines.

With rotor 12, drive engine 10 comprises a stator 13 with a stator core 14 and stator winding heads 15. Stator 13 is mounted in an engine housing 16, in which rotor shaft 11 is also mounted rotatably.

Drive engine 10 also comprises, in a flanged power electronics housing 19 (also called a penthouse), power electronics 20 for driving of drive engine 10.

Output drive 30 is arranged in a gear housing 32, which is connected fixedly to engine housing 16, in particular screwed. For the transmission of speed-converted torque from rotor shaft 11 to two output shafts 38.1 and 38.2, output gear 30 comprises a spur gear stage 34 and a differential 36.

For the temperature control of drive engine 10 and gearing 30, electromotive drive unit 1 comprises a drive cooling arrangement 2 with two coolant circuits 40 and 61, which can exchange heat via a heat exchanger 50.

A first coolant circuit 61 is formed with a cooling water as first coolant W; a second coolant circuit 40 is constituted with an electrically non-conductive gear cooling oil as second coolant O.

Second coolant circuit 40 comprises an oil pump 42 for conveying cooling oil O, which is collected in an oil collector 44 of second coolant circuit 40, in an oil mass flow 41. The oil mass flow conveyed by oil pump 42 serves to supply the components of drive engine 10 and the components of gearing 30 with cooling oil.

For cooling the electric drive engine 10, an engine cooling path 46 is provided in second coolant circuit 40, which extends from oil pump 42 up to oil collector 44 and passes through oil-water heat exchanger 50 of cooling circuit 140 upstream of an engine cooling section 48 for cooling the cooling oil and can exchange heat there with cooling water W of first coolant circuit 61.

Oil-water heat exchanger 50 is supplied on the water side for this purpose with a water mass flow 43, which originates from a vehicle cooling circuit otherwise not represented.

Engine cooling section 48 forms here a part of a stator cooling arrangement 58, i.e. stator winding head cooling 62.1 and 61.2 (as oil spray guns out of engine housing 16 into the workspace of electric drive engine 10), as well as rotor cooling 64 with rotor shaft cooling 66, which comprises outlets for rotor winding head cooling 68.

The other part of stator cooling arrangement 58, i.e. stator core cooling 60, is constituted by a water jacket, which is part of first coolant circuit 61 and through which water mass flow 43 flows as first coolant W.

First coolant circuit 61 also feeds oil-water heat exchanger 50 on the water side and can be provided in addition for cooling power electronics 20.

Correspondingly, engine cooling section 48 of engine cooling path 246 of second coolant circuit 40 does not form stator core cooling 60, but only stator winding head cooling 62 and rotor cooling arrangement 64 with rotor shaft cooling, which constitutes rotor core cooling 66 and outlets for rotor winding head cooling 68. Cooling oil O, which is injected into the engine workspace, runs back—in particular by a gravity effect—into oil collector 44, from where it can be fed by oil pump 42 back to oil mass flow 41.

Stator cooling arrangement 58 and rotor cooling arrangement 64 constitute together a drive cooling arrangement 2.

For cooling of output gear 30, a gear temperature-control path 52 is provided, which extends from oil pump 42 up to oil collector 44 and which can also be regarded in the exemplary embodiment as part of drive cooling arrangement 2. Oil mass flow 41 in second coolant circuit 40 comprises a junction 56 after heat exchanger 50, at which junction engine cooling path 146 and gear temperature-control path 52 split up. Gear temperature-control path 52 is led from junction 56 to and into gear housing 32 and constitutes a gear cooling section 54 inside gear housing 32. Cooling oil O, which is thereby sprayed into the gear workspace, runs—particular by a gravity effect and/or by a suction effect of oil pump 42—back into oil collector 44, from where it can be fed by oil pump 42 back to oil mass flow 41. An oil sump of output gear 30 and oil collector 44 can also—in the gear base or outside thereof—be constituted with a single, common oil reservoir.

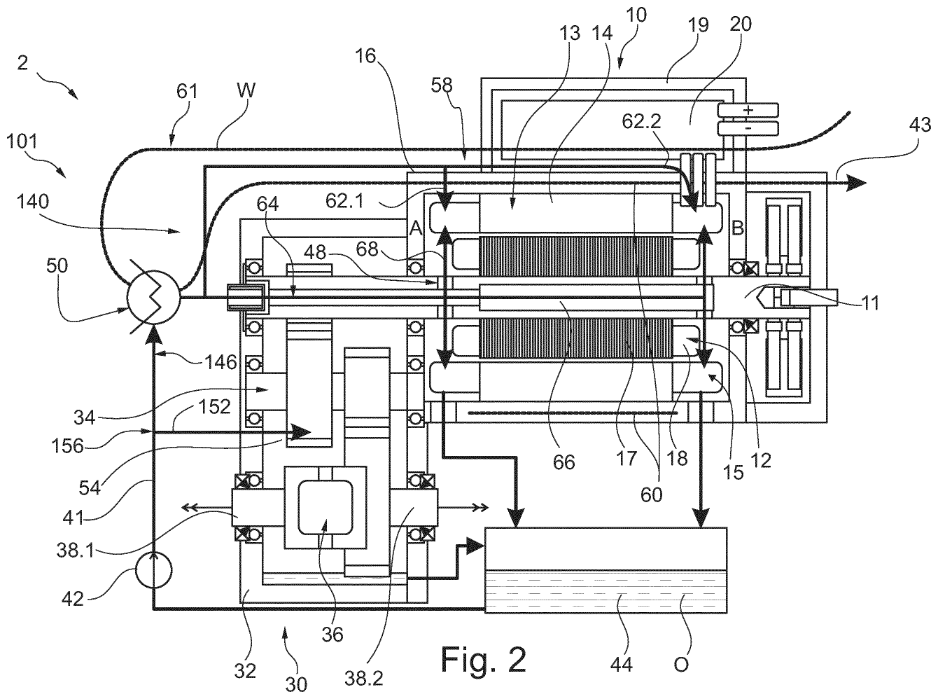

FIG. 2 represents a drive unit 101, which differs from drive unit 1 from FIG. 1 in particular by the fact that junction 156—at which gear temperature-control path 152 and engine cooling path 156 split up—is arranged in the flow of second coolant O upstream of heat exchanger 50.

Gear temperature-control path 52 is thus led past heat exchanger 50 into gear housing 32 and is thus constituted as a heat exchanger bypass, as a result of which second coolant circuit 140 differs from second coolant circuit 40 of drive unit 1 from FIG. 1.

The proportion of oil mass flow 41, which is used for the lubrication of the gearing, is therefore not cooled in this exemplary embodiment in oil-water heat exchanger 50, i.e. this partial mass flow is branched off upstream. As a consequence of this, an approx. 15 Kelvin higher oil temperature is established in the gearing, which creates advantages in the efficiency on account of the temperature dependence of the viscosity of the cooling oil.

The boundary conditions for the design of second coolant circuit 140 are as follows in the case of exemplary drive unit 101: 1. Water supply temperature approx. 55° C.; 2. Water volume flow approx. 10 l/min; 3. Oil temperature after oil-water heat exchanger approx. 75° C.; 4. Oil volume flow output gear 30 max. 4 l/min; 5. Oil volume flow rotor max. 4 l/min; 6. Oil volume flow stator max. 8 l/min; 7. Oil volume flow total max. 16 l/min; 8. Heat capable of being dissipated via oil-water heat exchanger 50: approx. 10 Kw with 15K temperature difference.

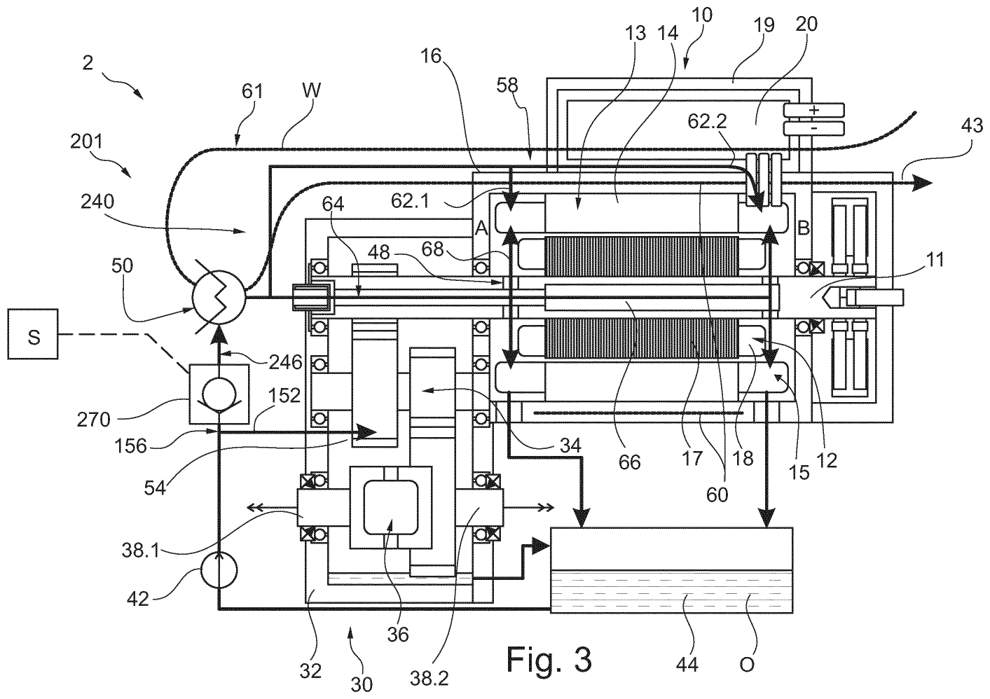

FIG. 3 represents a drive unit 201, second coolant circuit 240 of which differs from second coolant circuit 140 of drive unit 101 from FIG. 2 in particular by a branch valve 270, which is arranged here after junction 156 in an engine cooling path 246 and can completely or partially close engine cooling path 246 when it is correspondingly actuated by control unit S.

The control unit is designed to partially or completely close engine cooling path 246 when an operating state is ascertained for which a temperature control of output gear 30 is more important than a maximum cooling of electric engine 10. Depending on the extent to which engine cooling path 346 is blocked (completely or a degree of partial blocking), varyingly greater cooling oil flow rates are established for the temperature control of output gear 30 and a correspondingly adapted temperature control effect, for example in the case of a cold start to achieve quicker heating of output gear 30 to an operating temperature and thus to minimize friction losses.

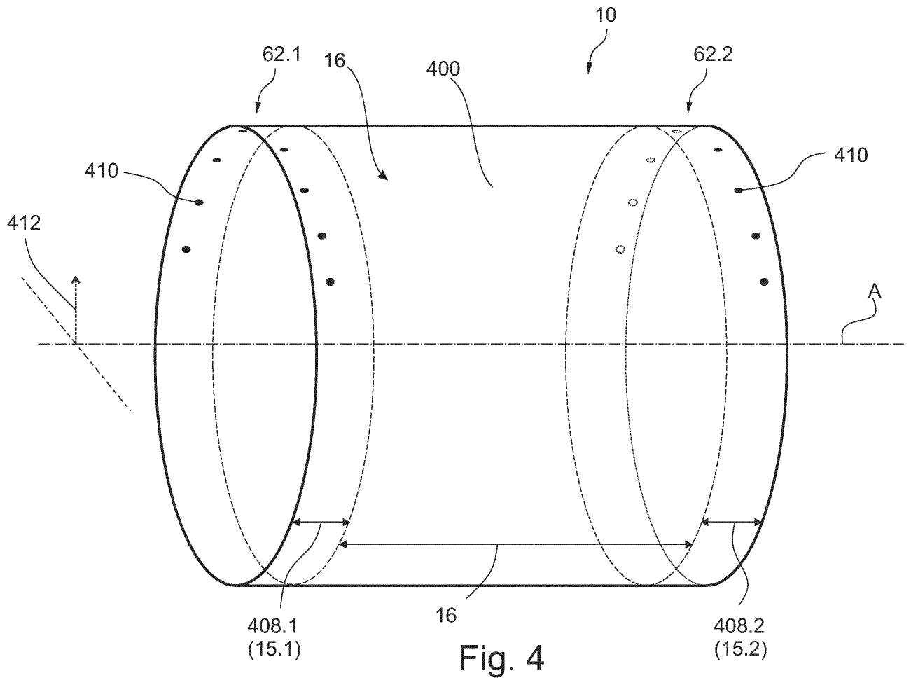

FIG. 4 represents an exemplary embodiment of stator winding head cooling 62.1 (or 62.2), which can be used in all the exemplary embodiments of FIGS. 1, 2 and 3.

Engine housing 16 comprises a stator cooling jacket 400, to the internal jacket of which an external jacket of stator core 14 to be cooled is fixed.

Stator cooling jacket 400 extends axially over an axial extension of stator core 16 on both sides along a rotation axis A of drive engine 10. In a projection 408.1 and/or 408.2 of stator cooling jacket 400 thus formed, a plurality of outlet openings 410 as stator cooling 62.1 and/or 62.2 are arranged in each case (on both sides) over the axial extension of stator core 16.

Outlet openings 410 are arranged in an axial extension region of the respective (not represented in FIG. 4) stator winding head 15, in order to be able to cool the latter thoroughly by sprayed-out second coolant O.

For a uniform distribution of second coolant O on respective stator winding head 15, the plurality of outlet openings 410 are arranged distributed spaced apart in the circumferential direction in an upper circumferential half 412, in particular uniformly spaced apart.

Outlet openings 410 constitute a coolant outlet into the housing interior and thus also the workspace of drive engine 10.

A feeding cooling channel, as part of engine cooling path 46, 146 or 246, is constituted completely or partially in a housing body of engine housing 16, in particular formed out of the housing, or constituted in a separate sealing element (not represented).

LIST OF REFERENCE NUMBERS

| | |
|---|---|
| 1, 101, 201 | electromotive drive unit |
| 2 | drive cooling arrangement |
| 10 | electric drive engine |
| 11 | rotor shaft |
| 12 | rotor |
| 13 | stator |
| 14 | stator core |
| 15 | stator winding heads |
| 16 | engine housing |
| 17 | rotor core |
| 18 | rotor winding heads |
| 19 | power electronics housing |
| 20 | power electronics |
| 30 | output gear |
| 32 | gear housing |
| 34 | spur gear stage |
| 36 | differential |
| 38 | output shaft |
| 40, 140, 240 | second coolant circuit |
| 41 | oil mass flow |
| 42 | oil pump |
| 44 | oil collector |
| 46, 146, 246 | engine cooling path |
| 48, 148 | engine cooling section |
| 50 | heat transfer point, in particular with heat exchanger |
| 52, 152 | gear temperature-control path |
| 54 | gear cooling section |
| 56 | junction of gear temperature-control path after the heat |
| | exchanger |
| 58 | stator cooling arrangement |
| 60 | stator core cooling, i.e. water jacket |
| 61 | first coolant circuit |
| 62 | stator winding head cooling |
| 64 | rotor cooling arrangement |
| 66 | rotor shaft cooling |
| 68 | rotor winding head cooling |
| 156 | junction of gear temperature-control path before the heat |
| | exchanger |
| 270 | branch valve |
| 400 | stator cooling jacket |
| 408 | axial projection |
| 410 | outlet openings |
| 412 | upper circumferential half of the stator cooling jacket |
| O | second coolant, in particular cooling oil |
| S | control unit |
| W | first coolant, in particular water |

1-14. (canceled)

15. A stator cooling arrangement for a stator of an electric drive engine in a motor vehicle, comprising:
stator core cooling with a first coolant; and
stator winding head cooling with a second coolant that differs from the first coolant.

16. The stator cooling arrangement according to claim 15, wherein
the stator core cooling comprises a stator cooling jacket and/or wherein the first coolant is arranged outside a workspace of the electric drive engine.

17. The stator cooling arrangement according to claim 15, wherein
the stator winding head cooling comprises one or more outlet openings arranged radially outside stator winding heads for the second coolant, through which the second coolant is injected to the stator winding head into the workspace of the electric drive engine.

18. The stator cooling arrangement according to claim 15, wherein
the second coolant of the stator winding head cooling is electrically non-conductive.

19. The stator cooling arrangement according to claim 15, wherein a first coolant circuit for the first coolant and a second cooling circuit for the second coolant form a heat exchanger configured to transfer thermal energy between the first coolant circuit and the second coolant circuit.

20. The stator cooling arrangement according to claim 15, wherein the first coolant of the stator core cooling is a water-based coolant, and/or wherein the second coolant of the stator winding head cooling is an oil-based coolant.

21. A drive cooling arrangement, comprising:
the stator cooling arrangement according to claim 15; and
a rotor cooling arrangement that is formed with the second coolant.

22. The drive cooling arrangement according to claim 21, comprising:
a second coolant circuit, which is configured to supply the stator winding head cooling and the rotor cooling arrangement with the second coolant, and is configured to not supply the stator core cooling.

23. The drive cooling arrangement according to claim 22, wherein the second coolant circuit comprises an engine cooling path for cooling the electric drive engine, by which the rotor cooling arrangement and the stator winding head cooling is constituted.

24. The drive cooling arrangement according to claim 22, wherein the second coolant circuit comprises a gear temperature-control path for cooling an output gear.

25. The drive cooling arrangement according to claim 21, wherein the second coolant circuit comprises a junction upstream of a heat exchanger of the stator cooling arrangement, at which junction the engine cooling path and the gear temperature-control path split up.

26. The drive cooling arrangement according to claim 25, wherein a branch valve is provided in the second coolant circuit and is configured to adjust an oil mass flow at the junction, which branch valve can assume an open state and a closed state, wherein the engine cooling path is blocked in the closed state.

27. An electromotive drive unit for a motor vehicle, comprising:
an electric drive engine and an output gear for the electric drive engine; and
the stator cooling arrangement according to claim 15.

28. A method for operating a drive cooling arrangement according to claim 21, comprising:
determining an operating state of the drive engine; and
switching the branch valve depending on the ascertained operating state.
